(19) United States
(12) Patent Application Publication
(10) Pub. No.: US 2014/0168873 A1
(43) Pub. Date: Jun. 19, 2014

(54) MOUSE

(71) Applicants: HON HAI PRECISION INDUSTRY CO., LTD., New Taipei (TW); Fu Tai Hua Industry (Shenzhen) Co., Ltd., Shenzhen (CN)

(72) Inventor: SI-WEI CHEN, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/961,902

(22) Filed: Aug. 8, 2013

(30) Foreign Application Priority Data
Dec. 13, 2012 (CN) 2012105376445

(51) Int. Cl. G06F 3/0354

(52) U.S. Cl. CPC G06F 3/03543
USPC 361/679.4

(57) ABSTRACT

A mouse includes a first cover, a second cover, and a circuit board. The first cover is engaged with the second cover to define an opening and a receiving space between them. A hand passes through the opening to be located in the receiving space to manipulate the mouse. The receiving space defines four finger-shaped receiving portions for the hand. The second cover has a wheel in the first receiving portion, has a first key in the second receiving portion, and has a second key in the third receiving portion. When the hand manipulates the wheel, the first key, and/or the second key, the wheel, the first key, and/or the second key establish an electronic connection with the circuit board to allow the wheel, the first key, and/or the second key to perform operations.

### BACKGROUND

1. Technical Field

The disclosure relates to a mouse, and more particularly to a mouse having a shape of a hand.

2. Description of Related Art

When a user manipulates a mouse, a wrist joint of a hand rests on a table surface the whole time, and fingers operate a left-click button, a right-click button, and a scroll wheel of the mouse. However, it is very uncomfortable for the user to operate the mouse in that position for a long time.

Therefore, what is needed is a mouse to overcome the described shortcomings.

### BRIEF DESCRIPTION OF THE DRAWINGS

FIG. 1 is a perspective view of a mouse in accordance with an exemplary embodiment.

FIG. 2 is an exploded, perspective view of the mouse of FIG. 1.

### DETAILED DESCRIPTION

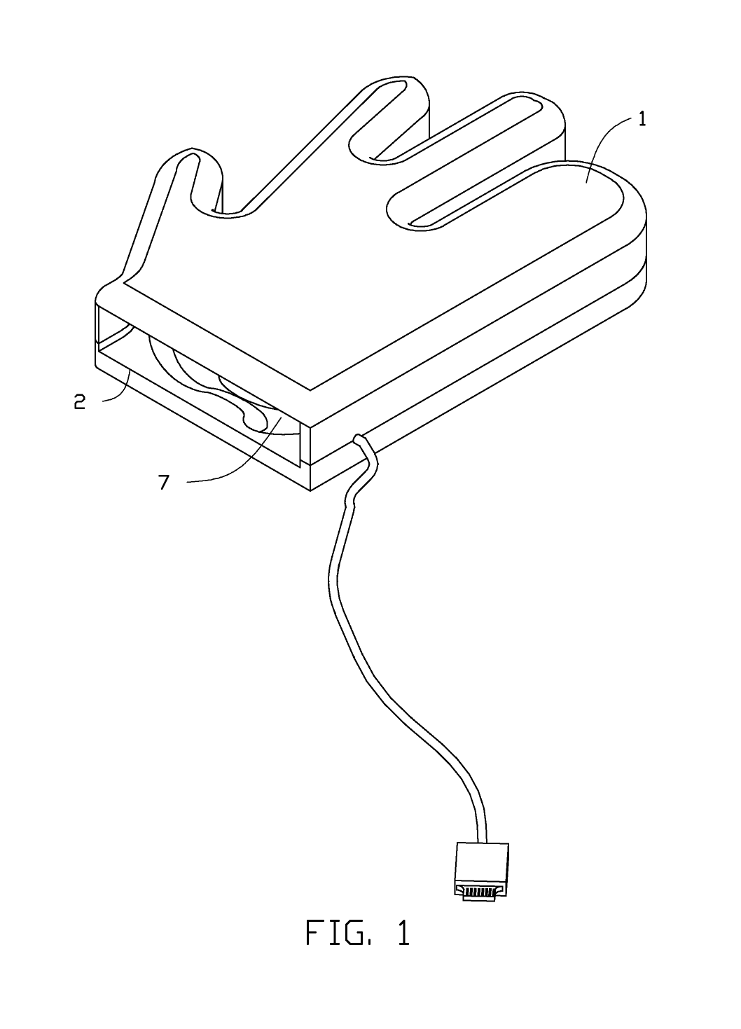

As shown in FIG. 1, a mouse 1 is a wired one. In another embodiment, the mouse 1 is a wireless one. The mouse 1 has a shape of a hand. The mouse 1 defines an opening 2 and a receiving space 7. A hand of a user can pass through the opening 2 and be received in the receiving space 7 in a natural position. Therefore, the user can manipulate the mouse 1 freely and comfortably.

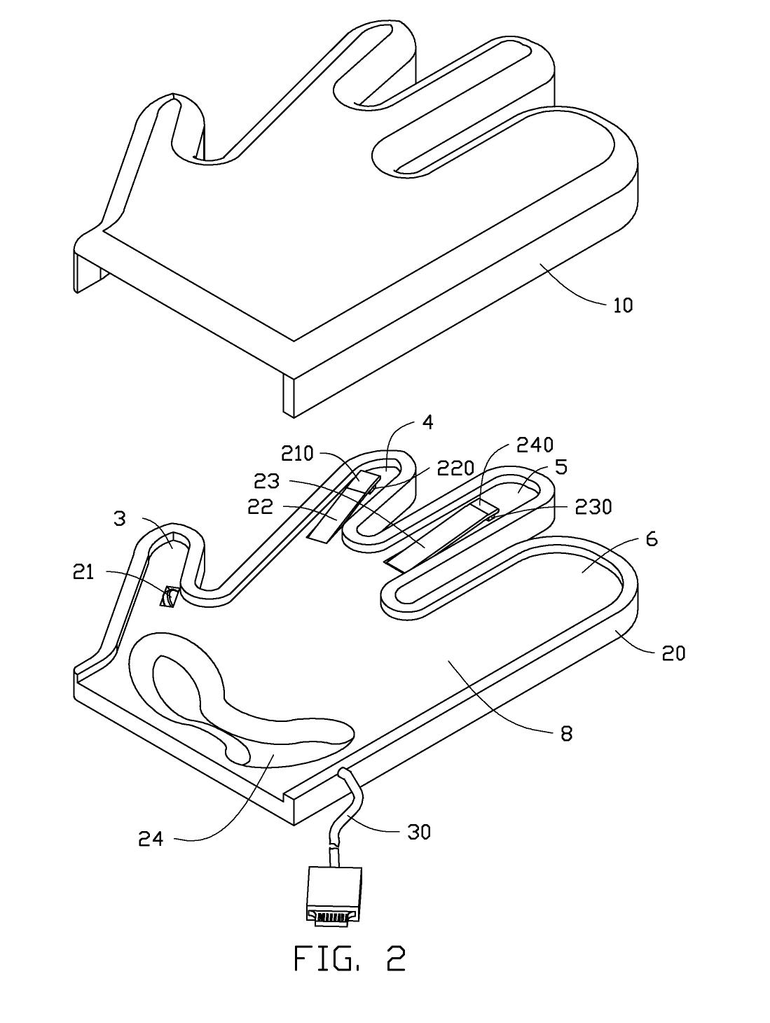

As shown in FIG. 2, the mouse 1 defines a cable 30 and is connected to an electronic device (not shown), such as a computer, via the cable 30. The mouse 1 includes an upper cover 10, a bottom cover 20, and a circuit board (not shown). The bottom cover 20 is connected to the circuit board. Both the upper cover 10 and the bottom cover 20 are filled with soft material, such as cotton. The soft material is attached on a bottom surface of the upper cover 10 and on an upper surface of the bottom cover 20. Therefore, the hand in the mouse 1 can keep warm in cold weather.

When the upper cover 10 is engaged with the bottom cover 20, the opening 2 and the receiving space 7 are defined between them. The receiving space 7 receives the hand. The receiving space 7 defines four finger-shaped receiving portions 3, 4, 5, and 6, and defines a palm-shaped receiving portion 8. When the hand is received in the receiving space 7, the thumb is received in the first receiving portion 3, the index finger is received in the second receiving portion 4, the middle finger is received in the third receiving portion 5, and both the ring finger and the pinky finger are received in the fourth receiving portion 6.

The bottom cover 20 has a wheel 21 in the first receiving portion 3, has a first key 22 in the second receiving portion 4, and has a second key 23 in the third receiving portion 5. The bottom cover 20 also defines a recess 24 in the receiving portion 8. The wheel 21 is on the left of the first key 22 and the second key 23. The recess 24 is adjacent to the opening 2. Each of the first key 22 and the second key 23 includes a spring clip and a contact board attached to the spring clip. A first contact board 220 is under a first spring clip 210 of the first key 22, and a second contact board 230 is under a second spring clip 240 of the second key 23. In an original state, the wheel 21, the first key 22, and the second key 23 are not electronically connected to the circuit board. When the wheel 21, the first key 22, and/or the second key 23 are operated by the hand, the wheel 21, the first contact 220, and/or the second contact 230 respectively establish an electronic connection with the circuit board in the bottom cover 20. The wheel 21, the first key 22, and the second key 23 serve as a scroll wheel, a left-click button, and a right-click button respectively of a conventional mouse.

An angle of about thirty degrees is formed between the wheel 21 and a line parallel to the opening 2. Therefore, when the thumb operates the wheel 21 in the first receiving portion 3, the thumb is in a comfortable position. When the wheel 21 is rotated by the thumb, the electronic device moves the display interface up or down accordingly.

When the user does not press the first key 22 and the second key 23, both the contact boards 220 and 230 do not contact the circuit board. When the user presses the first key 22, the contact board 220 contacts the circuit board to establish an electronic connection, and the electronic device performs a corresponding function in response to pressure on the first key 22, such as selecting an object. When the user presses the second key 23, the contact board 230 contacts the circuit board to establish an electronic connection, and the electronic device performs a corresponding function in response to pressure on the second key 23, such as opening a menu.

The recess 24 has a shape of a wrist joint. A depth of the recess 24 is about 9 mm. Therefore, when the user manipulates the mouse 1, the hand is in a comfortable position in the receiving space 7.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A mouse comprising:
a first cover;
a second cover; and
a circuit board;
wherein the first cover is engaged with the second cover, an opening and a receiving space are defined to receive a hand to manipulate the mouse, the receiving space defines four-finger shaped receiving portions, which comprise a first receiving portion to receive the thumb, a second receiving portion to receive the index finger, a third receiving portion to receive the middle finger, and a fourth receiving portion to receive the ring finger and the pinky finger; and
the second cover defines a wheel in the first receiving portion, a first key in the second receiving portion, and a second key in the third receiving portion, when the hand manipulates the wheel, the first key, and/or the second key, the wheel, the first key, and/or the second key are connected to the circuit board to establish an electronic connection.

2. The mouse as recited in claim 1, wherein both the first cover and the second cover are filled with soft material and the soft material is attached on a bottom surface of the first cover and an upper surface of the second surface.

3. The mouse as recited in claim 1, wherein the receiving space further defines a palm-shaped receiving portion, the palm-shaped receiving portion defines a recess and the recess has a shape of a wrist joint and is adjacent to the opening.

4. The mouse as recited in claim 3, wherein a depth of the recess is about 9 mm.

5. The mouse as recited in claim 1, wherein an angle of about thirty degrees is formed between the wheel and a line parallel to the opening.

6. The mouse as recited in claim 1, wherein the wheel is on the left of the first key and the second key.

7. The mouse as recited in claim 1, wherein each of the first key and the second key comprises a spring clip and a contact board attached to the spring clip, a first contact board is under a first spring clip of the first key, and a second contact board is under a second spring clip of the second key, when the wheel, the first key, and/or the second key are operated by the hand, the wheel, the first contact, and/or the second contact are connected to the circuit board.
